(19) United States
(12) Patent Application Publication
(10) Pub. No.: US 2008/0030465 A1
(43) Pub. Date: Feb. 7, 2008

(54) Removable dial with touch switch control and electroluminescent backlighting

(76) Inventors: Heather Konet, Canton, MI (US); Tomohito Hashikawa, West Bloomfield, MI (US); Francois Farion, West Bloomfield, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/496,802

(22) Filed: Aug. 1, 2006

(51) Int. Cl. G08B 1/08; G09G 5/08

(52) U.S. Cl. 345/158; 340/539.23

(57) ABSTRACT

An embodiment includes a control apparatus for at least partially controlling a component of a vehicle. The apparatus includes a knob having a body portion, a connection portion, and a conductive portion. The apparatus also includes a device having a proximity sensor and an illuminating portion. The conductive portion is selectively positioned adjacent the illuminating portion. The apparatus further includes a system controller in communication with the proximity sensor and the illumination portion. The system controller selectively detects movement of the conductive portion relative to the proximity sensor.

### TECHNICAL FIELD

The present invention generally relates to control knobs for devices.

### BACKGROUND

A proximity switch is a device that includes a structure that generates a magnetic field and circuitry that detects the proximity of an object (such as a finger or a metal or other conductive material) that disturbs the electric field when close to or in contact with the surface of the proximity switch. An inductive proximity sensor detects at least metals by generating a high-frequency electromagnetic field and detecting a change in the field when a metal passes therethrough. A proximity switch may utilize multiple proximity sensors, and multiple proximity sensors may be used in other control systems, such as volume or intensity controls. These sensors may operate without contact between the metal detected and the sensor. Generally, a non-conductive knob with a metal activating element embedded therein is used to actuate an inductive proximity sensor.

Currently proximity switch applications in automotive interiors include LEDs for switch backlighting. The basic proximity switch assembly includes an A-surface faceplate with screen printed translucent graphics. A light lens (or diffusion layer) adheres directly to the back of the A-surface faceplate. Below the light lens is an electronics layer that houses the LED light sources positioned below the face plate graphics and the proximity switch sensing pads. These switches may take up an undesirable amount of space in certain applications.

Many automobiles utilize control knobs to operate equipment within the vehicle, such as headlights radios, or wipers. These knobs may become worn or lost, or may not be of a pattern or style that is desirable to a user, such as a driver. Additionally, conventional knobs necessarily have a space between the knob and the control device that is difficult to clean. What is needed, therefore, is a control system in a vehicle that includes a knob that may be readily removed and reinstalled, while permitting newer technologies, such as proximity switches and inductive proximity sensors to be used. A favorable system would also permit the use of the control in the absence of the knob.

### SUMMARY

An illustrative embodiment includes a control apparatus for at least partially controlling a component of a vehicle. The apparatus includes a knob having a body portion, a connection portion, and a conductive portion. The apparatus also includes a device having a proximity sensor and an illuminating portion. The conductive portion is selectively positioned adjacent the illuminating portion. The apparatus further includes a system controller in communication with the proximity sensor and the illumination portion. The system controller selectively detects movement of the conductive portion relative to the proximity sensor.

### BREIF DESCRIPTION OF THE DRAWINGS

FIG. 1 is a side view of an exemplary vehicle.

FIG. 2 is a perspective view of an interior portion of the motor vehicle of FIG. 1, taken generally along the line 2-2 of FIG. 1.

FIG. 3 is an enlarged end view of an embodiment of a control switch.

FIG. 4 is a partial sectional view of the switch of FIG. 3, taken along line 4-4 of FIG. 3.

FIG. 4A is an enlarged view of portion 4A of FIG. 4, with portions removed for clarity.

FIG. 4B is an enlarged view of portion 4B of FIG. 4, with portions removed for clarity.

FIG. 5 is an enlarged view of a portion of FIG. 4.

FIG. 6 is an enlarged end view of a second embodiment of a control switch.

FIG. 7 is a partial sectional view of the switch of FIG. 6, taken along line 7-7 of FIG. 6.

FIG. 8 is a partial sectional view of a third embodiment of a switch, with FIGS. 3 or 5 being a representative end view.

FIG. 9 is a partial sectional view of a fourth embodiment of a switch, with FIGS. 3 or 5 being a representative end view.

FIG. 10 is a partial sectional view of a fifth embodiment of a switch, with FIGS. 3 or 5 being a representative end view.

### DETAILED DESCRIPTION

Referring now to the drawings, preferred illustrative embodiments are shown in detail. Although the drawings represent some embodiments, the drawings are not necessarily to scale and certain features may be exaggerated, removed, or partially sectioned to better illustrate and explain the present invention. Further, the embodiments set forth herein are not intended to be exhaustive or otherwise limit or restrict the claims to the precise forms and configurations shown in the drawings and disclosed in the following detailed description.

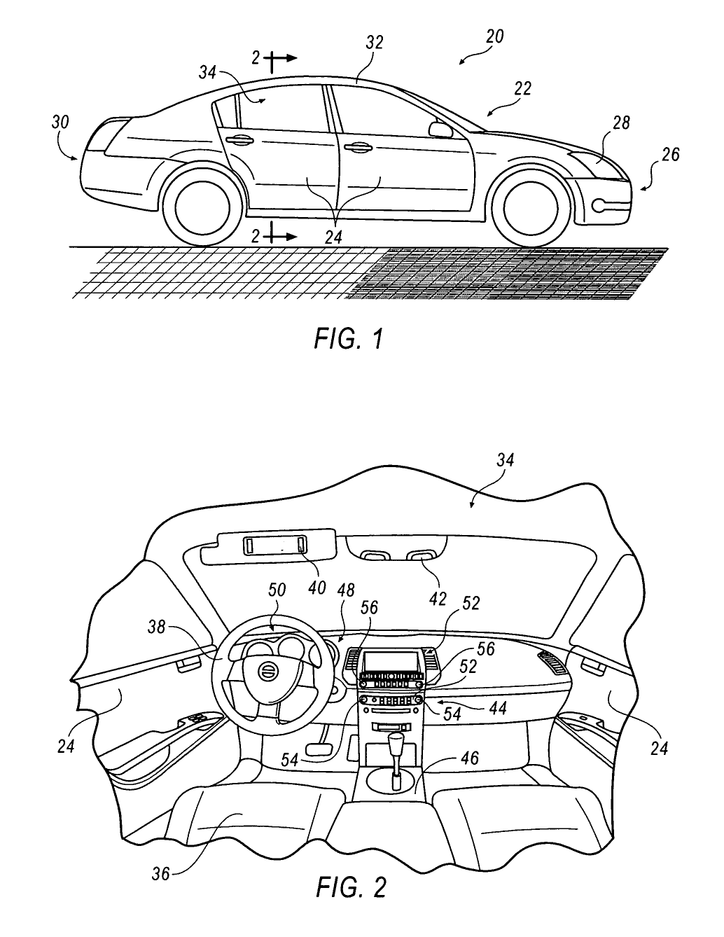

As best seen in FIG. 1, a vehicle 20 is illustrated. Vehicle 20 includes a body 22, doors 24 attached thereto, a front end 26 having headlights 28, a rear end 30, a roof 32, and a cabin, or interior, 34. Referring now to FIG. 2, a portion of the interior 34 is illustrated. Interior 34 includes a driver's seat 36, a steering wheel 38, a sun visor 40, and may further include an overhead console 42, a center console 44, a floor console 46, a dash console 48, including an instrument cluster 50, and a communication interface control 52, such as a radio, CD player, cellular telephone, navigation system, etc. Each of the sun visor 40, overhead console 42, center console 44, floor console 46, dash console 48, and instrument cluster 50 may also include controls 54 for operating various operative components for a driver or other passenger, with a typical control 54 illustrated at least on the center console 44 and the dash console 48. Also provided for the passenger or driver is a heating, ventilation, and air conditioning (HVAC) control, such as an air conditioning control 56.

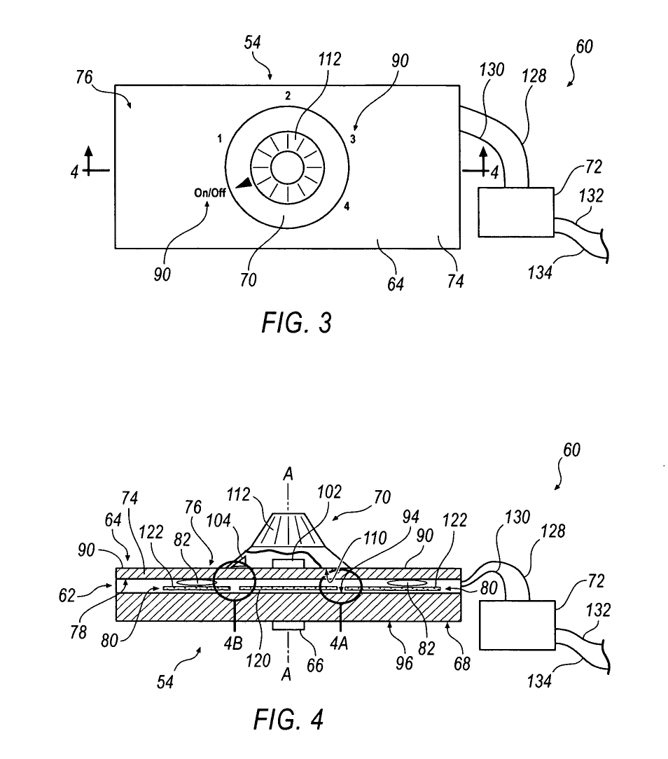

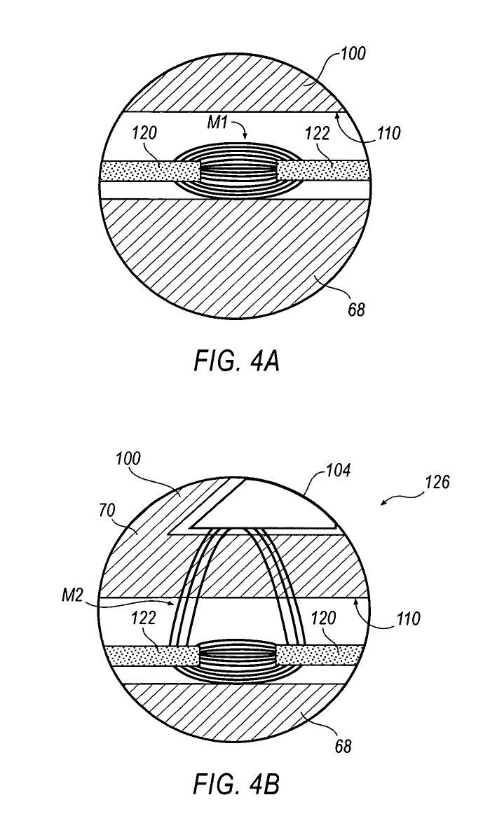

As best seen in at least one of FIGS. 3 and 4, each control 52, 54, 56 is part of a control system, such as a control system 60. Control system 60 includes a switch portion 62, a faceplate 64, a faceplate connecting portion 66, a substrate 68, a knob 70, and a system controller 72. Faceplate 64 includes a film 74, having an outer side 76 and an inner side 78. Switch portion 62 includes at least portions of layers of electroluminescent and touch switch materials positioned between faceplate 64, and substrate 68, as described herein. In the embodiment illustrated, outer side 76 of faceplate 64 is the outermost portion of the center console 44. Faceplate 64 may be a film of material that is transparent, translucent, or some combination thereof. Faceplate connecting portion 66 may be positioned within the substrate 68, or on either side of the substrate 68.

In the embodiment illustrated in FIGS. 3 and 4, inner side 78 has a touch switch pad, or inductive proximity sensor 80 printed on at least portions thereof, and an electroluminescent portion 82 printed on at least portions thereof. The electroluminescent portion 82 provides a backlit portion for the faceplate 64. Indicia 90 (FIG. 3) may be printed on the inner side 78, and may also be printed, or otherwise applied to outer side 76. Indicia 90, such as symbols, numbers or letters that identify various rotational orientations of knob 70, printed or otherwise formed on inner side 78 is protected between inner side 78 and electroluminescent portion 82 from damage or obfuscation. Preferably, portions of faceplate 64 with indicia 90 printed thereon are either transparent or translucent. Substrate 68 has a first side 94 facing switch portion 62, and a second side 96. Inductive proximity sensor 80 and electroluminescent portion 82 of switch portion 62 are preferably positioned between first side 94 and inner side 78.

As best shown in FIGS. 4A and 4B, knob 70 includes a body portion 100, a connection portion 102 (as best seen in the partial cut-away in FIG. 4), and a conductive portion 104 (as best seen in FIG. 4B). Body portion 100 includes a faceplate interface surface 110 (FIG. 4) and a manipulating surface 112 to permit a user to manipulate knob 70. Faceplate interface surface 110 faces outer side 76 of faceplate 64 for relative movement therebetween. In the embodiment illustrated, connection portion 102 and faceplate connecting portion 66 are magnets that provide an attractive magnetic force generally about an axis A-A of the knob 70 (FIG. 4). When the knob 70 is positioned relative the faceplate 64, such as in the illustration of FIGS. 3 and 4, a magnetic attractive force retains knob 70 in about the position shown, thereby mounting the knob 70 to the faceplate 64, while permitting the knob 70 to rotate generally about the axis A-A.

FIG. 4A illustrates the magnetic inductive proximity sensor 80 in greater detail. The inductive proximity sensor 80 generates an electromagnetic field, as described in greater detail below. The conductive portion 104 interrupts the electromagnetic field, also as described in greater detail below.

The inductive proximity sensor 80 includes a first electrically conductive switch portion 120 and a second electrically conductive switch portion 122. Both the first electrically conductive switch portion 120 and the second electrically conductive switch portion 122 are preferably translucent. Collectively, the first electrically conductive switch portion 120, second electrically conductive switch portion 122, and conductive portion 104 form at least a portion of a proximity switch 126, as discussed in greater detail below. The first electrically conductive switch portions 120 are electrically separated and spaced apart from the second electrically conductive switch portions 122.

As mentioned above, the first and second electrically conductive switch portions 120 and 122 can be printed directly to the underside of the faceplate 64 at the same time. However it should be understood from the drawings and the description herein that the first electrically conductive switch portions 120 can be printed separately from the second electrically conductive switch portions 122. Further, the first electrically conductive switch portions 120 can be coated with an electrically insulating coating prior to printing of the second electrically conductive switch portions 122 to ensure electrical separation thereof. Likewise, the second electrically conductive switch portions 122 can be coated with an electrically insulating coating prior to printing of the first electrically conductive switch portions 120 to ensure electrical separation therefrom.

Proximity switches and inductive proximity sensors require very little space compared to mechanical switch technologies such as push-push switches, knobs and rocker switches. Electroluminescent films for electroluminescent element lighting also require very little space compared to other lighting technologies such as incandescent light bulbs and LEDs (Light Emitting Diodes).

Each of the proximity switches 126 of the vehicle 20 operates in generally the same manner. Therefore description below of one proximity switch applies to all the proximity switches 126. The controller 72 may control one or more proximity switches, such as the proximity switch 126.

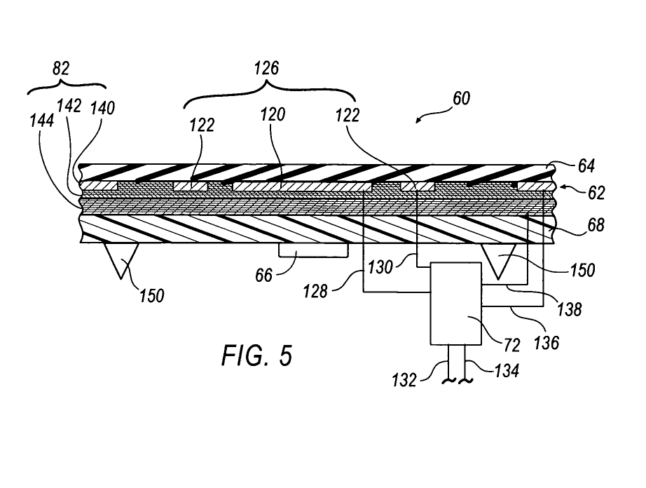

A single set of the first and second electrically conductive switch portions 120 and 122 is shown diagrammatically in FIGS. 4, 4A, 4B and 5 to demonstrate the operation of the proximity switch 126 and each of the proximity switches in the various embodiments described below.

As shown in FIG. 4, the second switch portion 122 surrounds the first switch portion 120 but is spaced apart therefrom. The first and second electrically conductive switch portions 120 and 122 are connected to controller 72 by power lines 128 and 130, respectively. The controller 72 is supplied with DC electricity by power lines 132 and 134 from, for example, a battery (not shown) within the vehicle 20. The controller 72 includes conventional circuitry (not shown) that converts the DC electricity to AC electricity. The controller 72 is also provided with power lines 136 and 138 that are connected to the electroluminescent portion 82 (as described further below).

It should be understood from the drawings and the description herein that in the first embodiment of the present invention the power lines 128 and 130 are connected to every one of the first and second electrically conductive switch portions 120 and 122, respectively, of the proximity switch 126. Further, for one or more of the proximity switches 126, at least a portion of the first and second electrically conductive switch portions 120 and 122 are applied on the faceplate 64 to at least partially coincide with the translucent portion. Further, at least a portion of one or more of the first electrically conductive switch portions 120 is at least partially disposed directly beneath the indicia 90 (the visible graphic).

The proximity switch 126 operates as follows. When activated by a supply of AC power from the controller 72, the electric potential between the second switch portion 122 and the first switch portion 120 creates a magnetic field M1 indicated in FIG. 4A. The controller 72 includes conventional attenuated circuitry and/or programming that detect fluctuations in the magnetic field M1 resulting from proximity or touch of the conductive portion 104, indicated as altered magnetic field M2, in FIG. 4B. Once the controller 72 detects a disturbance in the magnetic field M1, the controller 72 may send a control signal, or complete an electrical circuit to control an operative device, such as the headlights 28, or communication interface control (radio, CD player, cellular telephone, navigation system) 52, or controls 54, 56. Additionally, the electroluminescent portion 82 may be supplied with power such that when the controller 72 detects a disturbance in the magnetic field M1, the electroluminescent portion 82 illuminates.

The controller 72 operates as follows. Power is provided to the controller 72, for example, when the vehicle 20 is operating or when the ignition switch (not numbered) is turned on. The controller 72 supplies power to each of the proximity switches 126 such that each of the proximity switches 126 generates the magnetic fields M1 (FIG. 4A). The controller 72 senses for any activity in any one or any group of the proximity switches 126 in the array of proximity switches 126. The controller 72 senses an input from one or more of the proximity switches 126, for example, a disturbance by the conductive portion 104, is such an input. The controller 72 then sends a control signal to an operative device, such as headlights 28, or the heating or air-conditioning systems (not shown). The control signal sent may result in a power-on, power-off, or adjustment, such as low-beam or high-beam.

The controller 72 may also determine whether or not the electroluminescent portion 82 is illuminated or not (on or off). If the electroluminescent portion 82 is off, then the controller 72 may turn the electroluminescent portion 82 on, or not. If the electroluminescent portion 82 is on, then the controller 72 may turn the electroluminescent portion 82 off, or not. The controller 72, after sending the desired control signal, awaits a subsequent input from a proximity switch, such as the proximity switch 126.

The controller 72 is configured to sense magnetic field perturbations in any one of the proximity switches 126, or any group of the proximity switches 126. Consequently, a driver or passenger of the vehicle 20 can rotate knob 70 to bring the conductive portion 104 in close proximity to the proximity switches 126 and cause the electroluminescent portion 82 to either illuminate or stop illuminating (turn on or turn off). The proximity or touch of the conductive portion 104 is desirably within the arc of rotation of the conductive portion 104 about the axis A-A.

The electroluminescent portion 82 is now described in greater detail with reference to FIGS. 4 and 5. The electroluminescent portion 82 is disposed beneath the faceplate 64 to provided backlighting to the faceplate 64. More specifically, the electroluminescent portion 82 provides illumination to highlight the indicia 90 printed on the outer layer.

As shown in FIG. 5, the electroluminescent portion 82 includes a first electrode 140, phosphor and dielectric materials 142, and a second electrode 144, with the phosphor and dielectric materials 142 disposed between the first and second electrodes 140 and 144. In the first embodiment, the first electrode 140 is formed by some or all of the first electrically conductive switch portions 120 of each proximity switch 126. The first electrically conductive switch portions 120 can be connected to the power line 136 or, are preferably connected to the power line 136 via circuitry within the controller 72 in order to serve as part of the first electrode 140 of the electroluminescent portion 82. Therefore, a portion of each proximity switch 126 of acts as a part of the first electrode 140.

The phosphor and dielectric materials 142 are depicted as a single layer in FIG. 5 but are preferably separate layers with the phosphor separate from the dielectric material. Alternatively, the phosphor and dielectric materials 142 can be a single layer that includes a mixture of the two materials.

The second electrode 144 is preferably a conductive layer of metallic material. The second electrode 144 can include any of a variety of electrically conductive materials. Preferably the second electrode 144 includes a material that has a high amount of reflectivity in order to maximize the light emitted from the electroluminescent portion 82. As shown in FIG. 5, the second electrode 144 is connected to the power line 138.

The electroluminescent portion 82 works in a conventional manner. Specifically, when the controller 72 switches on the electroluminescent portion 82, AC current is provided to the power lines 136 and 138. The fluctuating magnetic fields generated between the first and second electrodes 140 and 144, excites the phosphor causing it to produce light.

The substrate 68 is disposed beneath the electroluminescent portion 82 and the array of proximity switch 126. The substrate 68 includes attachment portions 150. The attachment portions 150 are shown schematically in the drawings, but can be snaps, clips, springs, apertures for receiving fasteners, or fasteners that attach to corresponding attachment receiving members (not shown) formed in a desired surface, such as the center console 44 of the vehicle 20.

The substrate 68 is depicted in FIGS. 4 and 5 as having a thickness greater that the faceplate 64, the switch portion 62 and the electroluminescent portion 82. Preferably, the substrate 68 is thicker in order to provide a generally rigid support for the switch portion 62. The substrate 68 preferably has a shape corresponding to the faceplate 64.

Although the faceplate 64 is depicted as having a generally planar shape, the faceplate 64 can be provided with a three dimensional profile. For instance the faceplate 64 can have a curved contour to blend in with the adjacent shapes and contours of the center console 44.

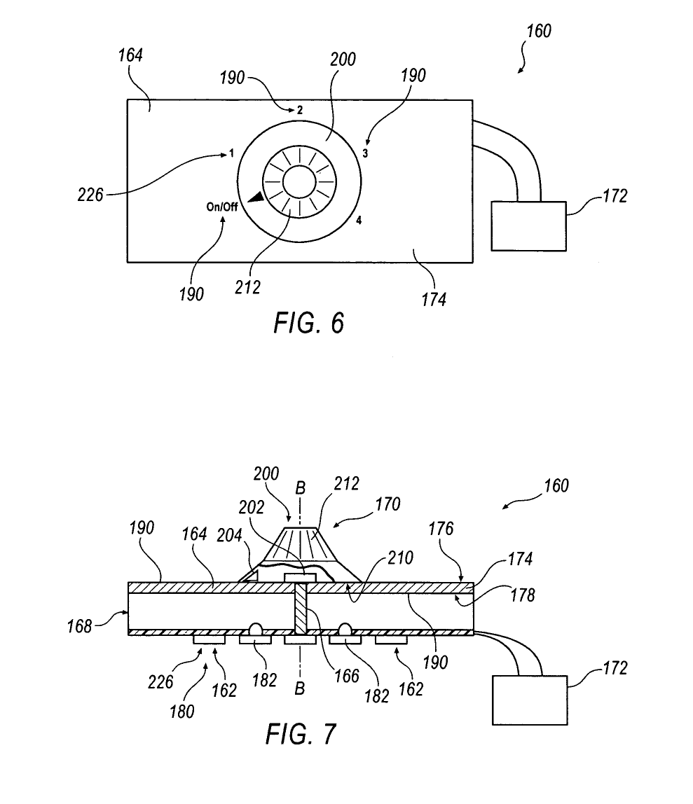

FIGS. 6 and 7 illustrate an embodiment of control 56 from FIG. 2. Control 56 is part of a control system 160. Control system 160 is another embodiment of the control system 60. Control system 160 includes a switch portion 162, a faceplate 164, a faceplate connecting portion 166, a light pipe 168, a knob 170, a system controller 172, and a controller circuit board 174. Faceplate 164 is preferably a film, having an outer side 176 and an inner side 178. Switch portion 162 includes at least portions of layers of touch switch materials positioned between controller circuit board 174, and a substrate (not shown), as described herein. In the embodiment illustrated, outer side 176 of faceplate 164 is an outermost portion of the center console 44. Faceplate 164 may be a film of material that is transparent, translucent, or some combination thereof. Faceplate connecting portion 166 is a connecting post that extends through the faceplate 164, light pipe 168, and controller circuit board 174 into knob 170, as discussed herein.

In the embodiment illustrated in FIGS. 6 and 7, controller circuit board 174 has switch portion 162 attached thereto. The switch portion 162 includes a touch switch pad, or inductive proximity sensor 180 (FIG. 7). The light pipe 168 includes LEDs 182 to provide a backlit portion for transparent and translucent portions of the faceplate 164. Indicia 190 (FIG. 6) may be printed on the inner side 178 of a translucent or transparent portion of faceplate 164, between inner side 178 and light pipe 168. Preferably, portions of faceplate 164 with indicia 190 printed thereon are either transparent or translucent.

Knob 170 includes a body portion 200 having an axis B-B, a connection portion 202, and a conductive portion 204. Body portion 200 includes a faceplate interface surface 210 and a manipulating surface 212 to permit a user to manipulate knob 170. Faceplate interface surface 210 faces outer side 176 of faceplate 164 for relative movement therebetween. In the embodiment illustrated, connection portion 202 is an aperture formed in the body portion 200, and faceplate connecting portion 166 is a connecting post inserted into connection portion 202 to mount knob 170 to the faceplate 164, and to permit rotation generally about the axis B-B of the knob 170 (FIG. 7).

The inductive proximity sensor 180 generates an electromagnetic field, in similar manner as the proximity sensor 80, to operate proximity switch 226 in similar fashion to the above described operation of proximity switch 126.

Controller 172 operates in similar fashion to control system 72, with at least the exception that a circuit board 174 is utilized to interconnect the controller 72, inductive proximity sensor 180, and LEDs 182, and the light tubes 168 transmit light from the LEDs 182 to the transparent and/or translucent portions of the faceplate 164.

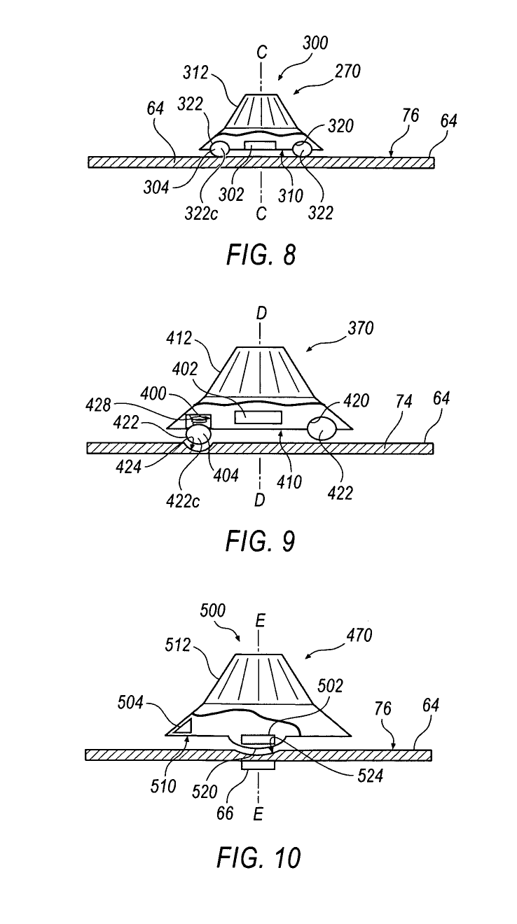

FIG. 8 illustrates an alternate embodiment of the knob 70 as a knob 270. Knob 270 includes a body portion 300 having an axis C-C, a connection portion 302, and a conductive portion 304. Body portion 300 includes a faceplate interface surface 310 and a manipulating surface 312 to permit a user to manipulate knob 270. Faceplate interface surface 310 faces outer side 76 of faceplate 64 (FIG. 4) for relative movement therebetween and includes detents 320 formed therein. Detents 320 have rollers 322 at least partially positioned therein. In the embodiment illustrated, one roller 322 (illustrated also as 322C) is conductive, so as to actuate the switch 126 (FIGS. 3 and 4) as the knob 270 is rotated about the axis C-C. Connection portion 302 (and faceplate connecting portion 66) are magnets that provide an attractive magnetic force generally about the axis C-C of the knob 270. When the knob 270 is positioned relative the faceplate 64, such as in the illustration of FIGS. 3 and 4, a magnetic attractive force retains knob 270 in about the position shown, while permitting the knob 270 to rotate generally about the axis C-C. Rollers 322 permit the knob 270 to easily rotate relative to the faceplate 64.

FIG. 9 illustrates an alternate embodiment of the knob 70 as a knob 370. Knob 370 includes a body portion 400 having an axis D-D, a connection portion 402, and a conductive portion 404. Body portion 400 includes a faceplate interface surface 410 and a manipulating surface 412 to permit a user to manipulate knob 370. Faceplate interface surface 410 faces outer side 76 of faceplate 64 (FIG. 4) for relative movement therebetween and includes detents 420 formed therein. Detents 420 have rollers 422 at least partially positioned therein. In the embodiment illustrated, one roller 422 (illustrated also as 422C) is conductive, so as to actuate the switch 126 (FIGS. 3 and 4) as the knob 370 is rotated about the axis D-D. Outer side 76 has an indicating detent, or indicating aperture, 424 formed therein. The detent 420 that partially houses the roller 422C has a spring 428 to bias the roller 422C away from the body portion 400. Connection portion 402 (and faceplate connecting portion 66) are magnets that provide an attractive magnetic force generally about the axis C-C of the knob 370. When the knob 370 is positioned relative the faceplate 64, such as in the illustration of FIGS. 3 and 4, a magnetic attractive force retains knob 370 in about the position shown, while permitting the knob 370 to rotate generally about the axis D-D. The indicating aperture 424 may be located at any desired position within the outer side 76, such as the off position for the proximity switch 126, to retain the knob 370 in the off position, and give a user a slight feedback (either audible or touch) when the knob 370 is rotated to a desired position where the roller 422C acts as a projection of knob 370 and is selectively positioned at least partially within indicating aperture 424.

FIG. 10 illustrates an alternate embodiment of the knob 70 as a knob 470. Knob 470 includes a body portion 500 having an axis E-E a connection portion 502, and a conductive portion 504. Body portion 500 includes a faceplate interface surface 510 and a manipulating surface 512 to permit a user to manipulate knob 370. Faceplate interface surface 510 faces outer side 76 of faceplate 64 (FIG. 4) for relative movement therebetween and includes a locating protuberance 520 formed therein. Outer side 76 has a locating aperture 524 formed therein. The connection portion 502 is preferably positioned at least partially within the locating protuberance 520. Connection portion 502 (and faceplate connecting portion 66) are magnets that provide an attractive magnetic force generally about the axis E-E of the knob 470. When the knob 470 is positioned relative the faceplate 64, such as in the illustration of FIGS. 3 and 4, the mating of the locating protuberance 520 within the locating aperture 524, combined with the magnetic attractive force retains knob 470 in about the position shown, while permitting the knob 470 to rotate generally about the axis E-E. Therefore, the locating protuberance 520 and the locating aperture 524 assist a user in properly locating the knob 470 relative a faceplate, such as the faceplate 64.

While control system 60 is illustrated with a magnetic retaining system (magnets at 66, 102), and control system 160 is illustrated with a conventional connection post (at 166), it would be recognized that either system 60, 160 could utilize either a magnetic retaining system, or a connection post, or both.

Additionally, if a user were to misplace a knob, such as knob 70, the user could use a finger to actuate the proximity switch 126, since a finger could disturb the magnetic field M sufficiently for actuation. In the embodiments illustrated, the knobs are rotatably mounted to the device, although knobs may be slidably mounted, or otherwise coupled to the faceplates.

The faceplates 64, 164, and light pipe 168 may be constructed of transparent, translucent, semi-translucent or opaque portions, or entirely of transparent, translucent, semi-translucent or opaque materials. The knobs are formed of a non-conductive material, such as ABS or other plastics, and a translucent or transparent material may be used, in conjunction with transparent portions of the faceplate to permit backlighting of any of the knobs described herein.

In order to more clearly describe the various embodiments, several terms are now defined as used herein. The term “transparent” as used herein refers to materials through which light is easily transmitted and through which visible objects, images and graphics can easily be discerned with the naked eye. For instance, clear glass and clear plastic materials are transparent. The term “translucent” as used herein refers to materials through which light is readily transmissible, but somewhat diffused such that objects, images and graphics are discernable with some difficulty through the material. Specifically, objects, images or graphics behind a translucent material are not as easily discerned compared to visibility through transparent materials. More specifically, a translucent material can be semi-transparent, but is not as transparent as clear glass.

The term “semi-translucent” as used herein refers to materials through which light is readily diffusible, but through which visible objects are generally obscured. An example of a semi-translucent material is a frosted glass through which light passes, but visible objects or images behind that material are not easily discerned by the naked eye. The shadow or outline of a visible object behind a semi-translucent material can be discerned, but the diffusion of light by the semi-translucent material obscures most if not all details of the visible object. The term “opaque” as used herein refers to materials through which light cannot pass, or materials that significantly restrict transmission or diffusion of light.

The term opaque as used herein can include materials that allow some slight amount of diffusion or transmission of light, but significantly less diffusion or transmission of light than a semi-translucent material. “Mounted” “mounting” and “mount” refers to the condition where the knobs are positioned and at least partially retained relative the devices, either by a connecting member, or by a magnet that is located in the knob or in the faceplate.

The preceding description has been presented only to illustrate and describe exemplary embodiments of the methods and systems of the present invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope. The scope of the invention is limited solely by the following claims.

What is claimed is:

1. A control apparatus for at least partially controlling a component of a vehicle, comprising:
a knob having a body portion, and a conductive portion;
a device having a proximity sensor and an illuminating portion, wherein the knob is positioned relative to the device; and
a system controller in communication with the proximity sensor and the illumination portion, wherein the system controller selectively detects movement of the conductive portion relative to the proximity sensor.

2. The apparatus of claim 1, wherein the system controller selectively controls a component of the vehicle in response to the detected movement of the conductive portion relative to the proximity sensor.

3. The apparatus of claim 1, wherein the system controller selectively illuminates the illumination portion in response to the detected movement of the conductive portion relative to the proximity sensor.

4. The apparatus of claim 1, wherein the knob is selectively positioned relative to the device with a magnet.

5. The apparatus of claim 1, wherein the system controller selectively controls a component of the vehicle in response to detected movement of a portion of a user relative to the proximity sensor.

6. The apparatus of claim 1, wherein the knob further includes a detent portion with a roller at least partially positioned therein, wherein the roller is selectively interposed between the knob and the device.

7. The apparatus of claim 1, wherein the device further includes a faceplate, interposed between the knob and the proximity sensor.

8. The apparatus of claim 7, wherein the faceplate includes a transparent or a translucent portion.

9. The apparatus of claim 8, wherein the faceplate selectively permits light emitting from the illuminating portion to at least partially pass therethrough.

10. A control system comprising:
a knob having a body portion, a connection portion, and a conductive portion;
a device having a faceplate, a substrate, and a at least a portion of a proximity switch and an electroluminescent portion interposed at least partially between the faceplate and the substrate, wherein the faceplate is selectively interposed between the knob and the substrate.

11. The apparatus of claim 10, wherein the faceplate further includes an indicating detent and the knob further includes a projection, wherein the projection is selectively positioned within the indicating detent.

12. The apparatus of claim 10, wherein the connection portion is selectively retained relative to the device with a magnet.

13. The apparatus of claim 10, wherein the knob is selectively rotatably coupled to the device.

14. The apparatus of claim 10, wherein the knob is selectively slidably coupled to the device.

15. The apparatus of claim 10, wherein the knob is formed of a non-conductive material and the conductive portion is formed of a metal.

16. The apparatus of claim 10, wherein at least portions of the proximity switch are printed on the faceplate.

17. The apparatus of claim 10, wherein at least portions of the electroluminescent portion are printed on the faceplate.

18. The apparatus of claim 10, wherein the faceplate selectively permits light emitting from the electroluminescent portion to at least partially pass therethrough.

19. The apparatus of claim 10, further comprising a system controller in communication with the proximity switch and the electroluminescent portion, wherein the system controller selectively detects movement of the conductive portion relative to the proximity switch.
